(19) United States
(12) Patent Application Publication
(10) Pub. No.: US 2012/0317788 A1
(43) Pub. Date: Dec. 20, 2012

(54) COUPLING ARRANGEMENT AND METHOD FOR MOUNTING A BODY TO A SURFACE

(75) Inventor: David WILL, Mobile, AL (US)

(73) Assignee: AIRBUS OPERATIONS GMBH, Hamburg (DE)

(21) Appl. No.: 13/160,147

(22) Filed: Jun. 14, 2011

(51) Int. Cl. F16B 9/00; B23P 11/00

(52) U.S. Cl. 29/525.02; 403/245

(57) ABSTRACT

An arrangement for fastening a body to a surface, the body having a bore defined there through, includes, but is not limited to, a fitting configured for attachment to the surface. The fitting has a first flange and a second flange spaced apart from the first flange. The first flange has a first opening and the second flange has a second opening substantially axially aligned with the first opening. The arrangement further includes a retaining pin configured to extend through the first opening, the bore, and the second opening when a portion of the body is positioned between the first flange and the second flange. The arrangement further includes a cover member configured to be fastened to the first flange and to obstruct outward movement of the retaining pin from the first opening, the bore, and the second opening when the cover member is fastened to the first flange.

### TECHNICAL FIELD

The technical field generally relates to fastening arrangements, and more particularly relates to an arrangement and a method for fastening a member to a surface.

### BACKGROUND

In the construction of aircraft interiors, fittings are commonly used to mount door posts to floors. The fitting is commonly bolted, welded, or otherwise secured to the floor. Once the fitting is secured to the floor, a doorpost (or other body) may be attached to the fitting. Through attachment to the fitting, the doorpost is securely yet removably anchored to the floor.

The fitting is configured to receive the doorpost. A conventional fitting includes two flanges that are spaced apart, each flange having an opening and each opening being axially aligned with the other. A doorpost (or other body) has a bore defined there through and is positioned between the two flanges such that the bore is aligned with the two openings in the flanges. A bolt is then inserted into the opening of the first flange and pushed through the bore and the opening of the second flange until a portion of the bolt protrudes through the opening of the second flange. A nut is then fastened to the distal end of the bolt. In this manner, the doorpost is mounted to the floor.

While the above described conventional coupling arrangement is adequate for many applications, there are some situations in which this arrangement is lacking. For example, the above-described arrangement requires access to both sides of the fitting. An installer needs to access one side of the fitting to insert the bolt, and will also need to access the other side of the fitting to position the nut to engage the bolt. In some circumstances, however, the configuration of the body that is being attached to the fitting may obstruct a single installer from simultaneously accessing both sides of the fitting. In such circumstances, two installers will be needed, one on each side of the fitting, and they will have to work cooperatively, each focusing on this single task, in order to mount the body to the fitting. In still other circumstances, regardless of the shape of the body being attached to the fitting, one side of the fitting may be inaccessible due to the presence of other structures adjacent to the fitting. In such circumstances, it can be unacceptably cumbersome and/or inconvenient to secure the nut to the bolt and, as a result, the body cannot be easily secured to the surface.

Accordingly, it is desirable to provide a coupling arrangement whereby a body (such as, but not limited to, a doorpost, door jamb, wall post, room divider, proscenium, sillboard, partition, or the like) may be mounted to a surface by a single installer regardless of the shape or configuration of the body. In addition, it is desirable to provide an arrangement whereby a body may be mounted to (or removed from) a surface in circumstances where the fitting used to mount the body is not conveniently accessible from both sides or accessible from only one side. Furthermore, other desirable features and characteristics will become apparent from the subsequent detailed description and the appended claims, taken in conjunction with the accompanying drawings and the foregoing technical field and background.

### SUMMARY

In a first non-limiting embodiment of a coupling arrangement for mounting a body to a surface, the body having a bore defined there through, the coupling arrangement includes, but is not limited to, a fitting that is configured for attachment to the surface. The fitting has a first flange and a second flange spaced apart from the first flange. The first flange has a first opening and the second flange has a second opening. The arrangement further includes a retaining pin that is configured to extend through the first opening, the bore, and the second opening when a portion of the body is positioned between the first flange and the second flange such that the bore is aligned with the first opening and the second opening. The coupling arrangement further includes a cover member that is configured to be fastened to the first flange and to obstruct outward movement of the retaining pin from the first opening, the bore, and the second opening when the cover member is fastened to the first flange.

In a second, non-limiting embodiment, a method is disclosed for mounting a body having a bore defined there through to a surface using a coupling arrangement including a fitting attached to the surface, the fitting having a first flange and a second flange spaced apart from the first flange, the first flange having a first opening and the second flange having a second opening substantially axially aligned with the first opening, the arrangement further including a retaining pin configured to extend through the first opening, the bore, and the second opening. The arrangement further includes a cover member configured to be fastened to the first flange and to obstruct outward movement of the retaining pin from the first opening, the bore, and the second opening when the cover member is fastened to the first flange. The method includes, but is not limited to, the steps of positioning the body between the first flange and the second flange such that the bore, the first opening, and the second opening are axially aligned. The method further includes inserting the retaining pin through the first opening, the bore and the second opening. The method further includes fastening the cover member to the first flange in a position that obstructs outward movement of the retaining pin from the first opening, the bore, and the second opening.

### DESCRIPTION OF THE DRAWINGS

One or more embodiments will hereinafter be described in conjunction with the following drawing figures, wherein like numerals denote like elements, and

FIG. 1 is an environmental view illustrating a portion of an aircraft interior looking in a forward direction towards a cockpit door, the cockpit door having a doorpost mounted to a floor surface via an arrangement for mounting a body to a surface according to the present disclosure;

FIG. 2 is a perspective view from an aisle of the aircraft interior illustrating a portion of the doorpost of FIG. 1 and the arrangement for mounting a body to a surface;

FIG. 3 is a perspective view from a monument side of the aircraft interior illustrating the portion of the doorpost of FIG. 1 and the arrangement for mounting a body to a surface;

FIG. 4 is a front elevational view illustrating the doorpost of FIGS. 1 and 2 with the arrangement for mounting a body to a surface in a partially exploded state;

FIG. 5 is a perspective view illustrating the arrangement for mounting a body to a surface without the doorpost present;

FIG. 6. is an exploded and partially fragmented view illustrating a retaining pin, a cover member, a restraining bolt and associated hardware items for use with the arrangement for mounting a body to a surface of FIG. 5;

FIG. 7 is an expanded view of a portion of the retaining pin of FIG. 6;

FIG. 8 is a perspective view illustrating a fitting for use with the arrangement for mounting a body to a surface of FIG. 5;

FIG. 9 is a fragmented perspective view of a lower portion of the doorpost of FIG. 2 prior to being mounted to the arrangement for mounting a body to a surface illustrated in FIG. 5; and

FIG. 10 is a block diagram illustrating an embodiment of a method for attaching a body to a surface.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

A coupling arrangement is disclosed herein that permits a single worker, acting alone, to mount a member (also referred to herein as a body) to a surface, even in circumstances where the worker may only have access to one side of the arrangement. The arrangement includes a fitting that is configured to be mounted to any surface including, but not limited to, a floor surface. The fitting includes a first flange and a second flange. The first flange and the second flange are spaced apart from one another. The first flange and the second flange have a first opening and a second opening, respectively. In the illustrated embodiment, the openings are axially aligned.

The body that is to be mounted to the surface has a bore that extends through the body. The body is positioned with respect to the two flanges such that the bore of the body is between, for example axially aligned with, the first and second openings of the first and second flanges.

A retaining pin is inserted into the assembly formed by the fitting and the body such that the retaining pin extends through the first opening, through the bore, and the second opening. The retaining pin includes a head portion that is configured to obstruct the retaining pin from passing entirely through the first opening. Accordingly, once the head portion is seated against the first flange, the retaining pin cannot be inserted any further into the first opening due to interference between the head portion and the first flange.

Once the retaining pin has been positioned in the first opening, the bore, and the second opening, a cover member is positioned over the head portion of the retaining pin and then fastened to the first flange. The cover member is configured to obstruct outward movement of the retaining pin from the assembly. Thus, when the cover member is in place over the retaining pin, the retaining pin cannot move into or out of the assembly. Specifically, interference between the first flange and the head portion of the retaining pin obstructs inward movement of the retaining pin into the assembly while interference between the cover member and the retaining pin obstruct outward movement of the retaining pin from the assembly. With the body secured to the fitting through engagement with the retaining pin, the body is securely mounted to the surface.

A further understanding of the above described arrangement and method for mounting a body to a surface may be obtained through a review of the illustrations accompanying this application together with a review of this detailed description.

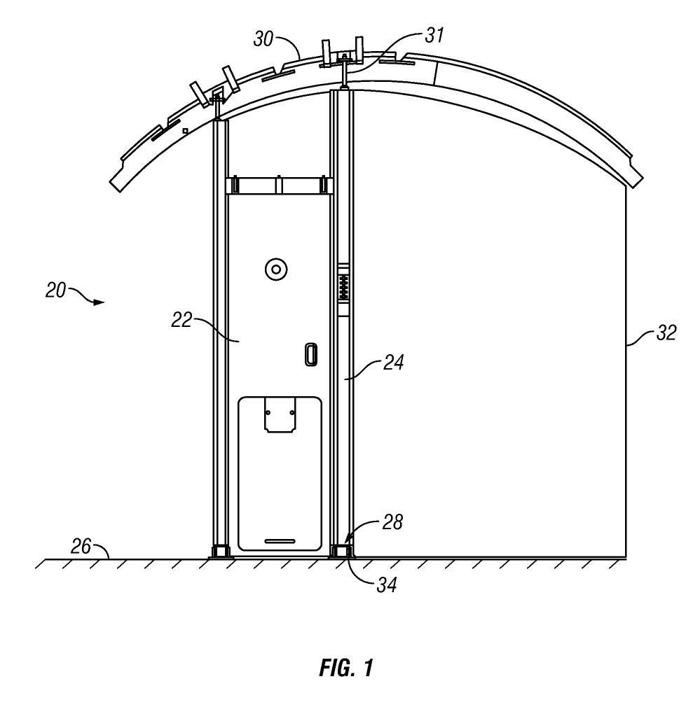

FIG. 1 is an environmental view illustrating a portion of an aircraft interior 20 looking in a forward direction towards a cockpit door 22. It should be understood that although the context of this description is with respect to aircraft, the teachings disclosed herein are equally applicable to any other environment where it is desirable to attach a body to a surface. Furthermore, although the context of this discussion is with respect to mounting a body to a floor surface, it should be understood that the teachings herein are equally applicable to situations where the body is mounted to any other surface, for example an interior or exterior wall, ceiling, or to another body.

Moreover, the coupling assembly described herein may be deployed in any type of vehicle such as a boat, railway car, truck, bus, trailer, or even in a stationary environment such as a warehouse, storage, or commercial facility.

Cockpit door 22 includes a doorpost 24. Doorpost 24 is mounted at a bottom end to a floor surface 26 via an embodiment of a coupling arrangement 28 for mounting a body to a surface. Doorpost 24 may also have one or more additional mounting points; that is, it may be mounted at an upper end to a ceiling 30 of aircraft interior 20. At such additional mounting points, a shock mount may be utilized to permit doorpost 24 some freedom to move in the Z (up/down) direction. For example, in FIG. 1, a shock mount 31 is utilized to mount the upper end of doorpost 24 to ceiling 30.

A monument 32 is positioned in relatively close proximity to doorpost 24. As used herein, the term “monument” refers to a structure on an aircraft that partitions space and, in some instances, forms a compartment. Examples of a monument include crew rest quarters, a galley, a lavatory, and the like. As illustrated in FIG. 1, monument 32 is spaced so closely to doorpost 24 and to coupling arrangement 28 that a construction worker attempting to attach doorpost 24 to floor surface 26 or attempting to remove doorpost 24 from floor surface 26 would have difficulty or even be obstructed from reaching the right-hand side (from the perspective of FIG. 1) of coupling arrangement 28. However, cockpit door 22 can be swung open to provide the construction worker with substantially unrestricted access to the left-hand side (from the perspective of FIG. 1) of coupling arrangement 28. As explained in detail below, coupling arrangement 28 is configured to permit the installation and removal of a body to a surface in instances where a worker has access to only one side of coupling arrangement 28.

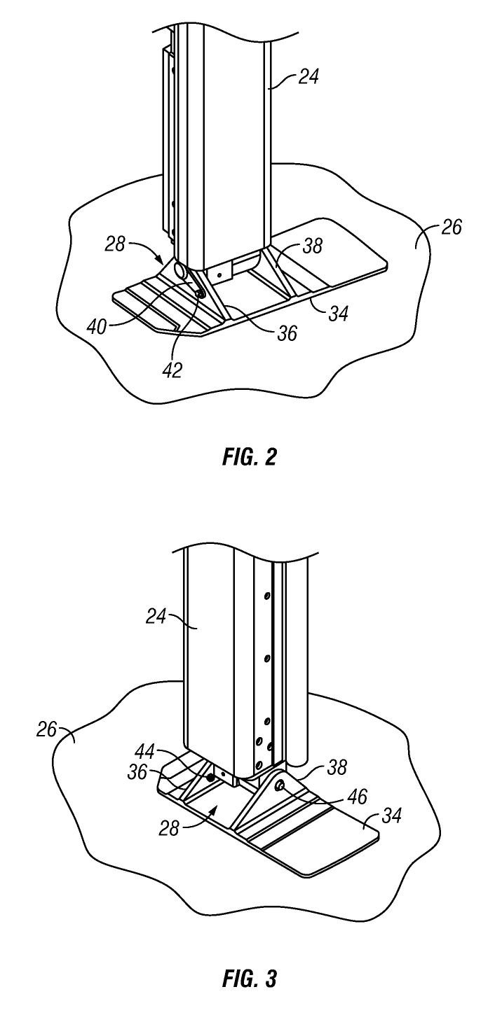

FIG. 2 is a perspective view from an aisle of the aircraft interior illustrating a portion of doorpost 24 and coupling arrangement 28. With continuing reference to FIG. 1, a fitting 34 of coupling arrangement 28 is depicted. Fitting 34 is configured to be permanently affixed to floor surface 26 of aircraft interior 20. Fitting 34 may be permanently affixed to floor surface 26 in any suitable manner including through the use of rivets, threaded fasteners, welds, or any other means that are effective to permanently attach fitting 34 to floor surface 26.

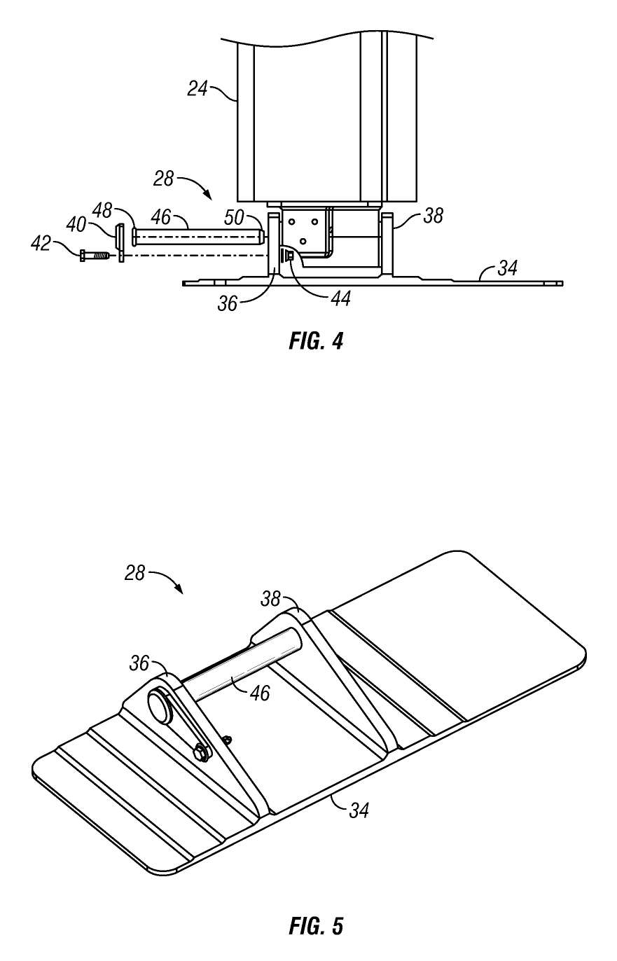

Fitting 34 includes a flange 36 and a flange 38. A lower portion of doorpost 24 is positioned between flange 36 and flange 38. A retaining pin (see FIG. 4) extends through flange 36, through the lower portion of doorpost 24, and through flange 38 to secure doorpost 24 to floor surface 26.

Also depicted in FIG. 2 is a cover member 40 and a restraining bolt 42. Restraining bolt 42 secures cover member 40 to fitting 34, for example at flange 36. Cover member 40 obstructs the retaining pin and inhibits the retaining pin from moving in an outward direction from flange 36, the lower portion of doorpost 24, and flange 38. The entire operation of securing doorpost 24 to floor surface 26 can be accomplished from the aisle of aircraft interior 20 without requiring any access to the side of fitting 34 where flange 38 is located.

FIG. 3 is a perspective view illustrating doorpost 24 and coupling arrangement 28 from a side opposite to that shown in FIG. 2. With continuing reference also to FIGS. 1-2, FIG. 3 depicts doorpost 24 and coupling arrangement 28 as seen from the position occupied by monument 32.

In FIG. 3, a restraining nut 44 is depicted positioned on an opposite side of flange 36 to that of restraining bolt 42. Restraining nut 44 is used to fasten restraining bolt 42 to flange 36. In some examples, restraining nut 44 may be an anchor nut (i.e, a nut that is permanently affixed to flange 36) while in other embodiments, restraining nut 44 may be any conventional nut that an operator may hold in place using their fingers or an appropriate tool while restraining bolt 42 is rotated.

Also depicted in FIG. 3 is a retaining pin 46. An end portion of retaining pin 46 is illustrated protruding through an opening in flange 38. Engagement between retaining pin 46 and flanges 36 and 38 inhibits movement of doorpost 24 in an upward direction (from the perspective of FIG. 3).

FIG. 4 is a front elevational view illustrating doorpost 24 and further illustrating coupling arrangement 28 in an exploded view. In this view, retaining pin 46 is illustrated in its entirety. Retaining pin 46 includes a head portion 48 at a proximal end, and a tapered portion 50 at its distal end. Head portion 48 abuts (i.e., lays flat against) flange 36 and thereby inhibits retaining pin 46 from passing entirely through flange 36. Tapered portion 50 facilitates insertion of retaining pin 46 through flange 36, door post 24 and flange 38 in the event that flange 36, door post 24 and flange 38 are slightly misaligned.

FIG. 5 is a perspective view illustrating coupling arrangement 28 without the doorpost present. In this view, retaining pin 46 can be seen extending between flange 36 and flange 38. With continuing reference to FIGS. 1-4, the extension of retaining pin 46 between flange 36 and flange 38 provides a robust mount for attachment of doorpost 24 (or any other body) to floor surface 26.

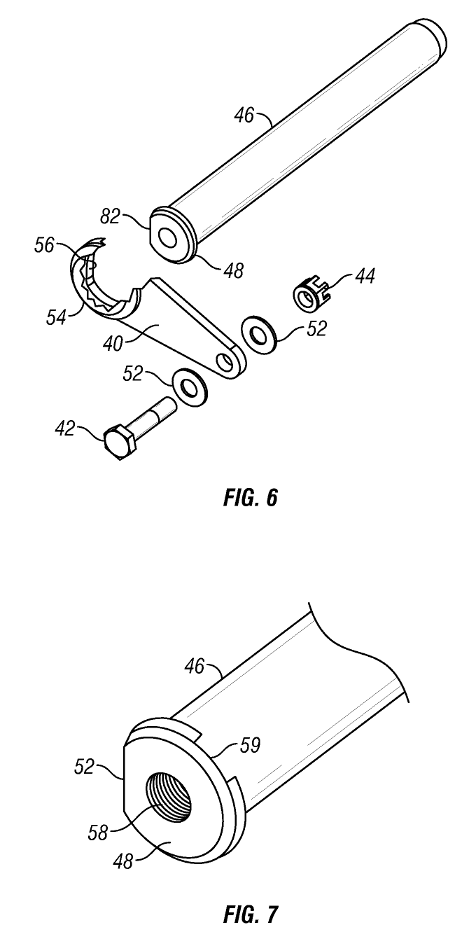

FIG. 6. is an exploded view illustrating retaining pin 46, cover member 40, restraining bolt 42, restraining nut 44 as well as a pair of washers 52. Head portion 48 of retaining pin 46 may include a flattened segment 82. Cover member 40 includes a pin receptacle 54, for example a cavity configured to receive head portion 48. The walls forming the cavity of pin receptacle 54 include a flattened portion 56. Flattened portion 56 is configured to engage flattened segment 82 when cover member 40 is positioned over retaining pin 46 and head portion 48 is received within the cavity of pin receptacle 54. Engagement between flattened portion 56 and flattened segment 82 inhibits retaining pin 46 from rotating about its longitudinal axis when deployed in coupling arrangement 28. This, in turn, reduces wear on retaining pin 46 and thus increases its useful life.

FIG. 7 is an expanded view of a portion of retaining pin 46 including head portion 48. With continuing reference also to FIGS. 1-6, two features are depicted in FIG. 7 that may be used to remove retaining pin 46 from coupling arrangement 28, for example if removal of door post 24 from floor surface 26 is desired. Both features are illustrated together on a single retaining pin for illustration purposes only. While some embodiments may include both features, it is anticipated that other embodiments would include either one feature or the other.

One of the features comprises of a threaded bore 58 that extends through head portion 48 and partially into a main body portion of retaining pin 46. In other embodiments, depending upon the size of head portion 48, threaded bore 58 may extend through a portion of head portion 48 without extending into a main body portion of retaining and 46. To remove retaining pin 46 from coupling arrangement 28 using threaded bore 58, a person need only screw a threaded bolt into threaded bore 58 and then apply force to the threaded bolt to pull it out of coupling arrangement 28. Once retaining pin 46 has been removed from coupling arrangement 28, the threaded bolt may be removed from threaded bore 58, and retaining pin 46 may be reused.

Another of the features depicted in FIG. 7 that may be used to remove retaining pin 46 from coupling arrangement 28 is a notch 59 defined in the underside of head portion 48. Notch 59 provides a space to position a prying device between an underside of head portion 48 and flange 36. Once a prying device is in position, retaining pin 46 may be pried free of coupling arrangement 28.

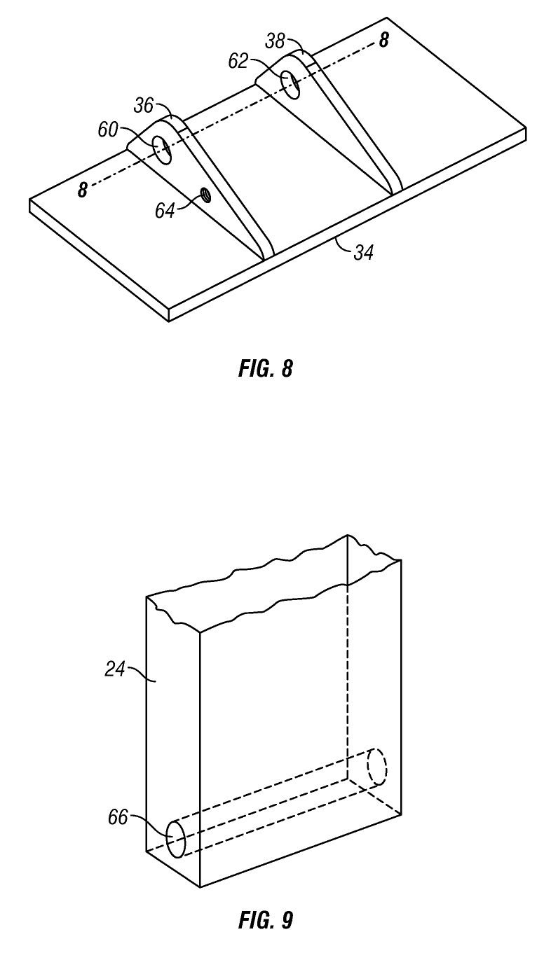

FIG. 8 is a perspective view illustrating fitting 34. With continuing reference also to FIGS. 1-7, flange 36 defines an opening 60 and flange 38 defines an opening 62. Openings 60 and 62 may be axially aligned along line 8-8 and are configured to receive retaining pin 46.

Flange 36 further includes an opening 64 configured to receive restraining bolt 42. In some embodiments, restraining bolt 42 will extend entirely through opening 64 and protrude through flange 36. The protruding portion can engage with restraining nut 44, as illustrated in FIGS. 2-4 to secure restraining bolt 42 to flange 36. In other embodiments, such as the embodiment illustrated in FIG. 8, opening 64 may include a threaded insert (e.g., Heli-Coil inserts offered by Holley Performance Products, Inc.) or threads defined directly in the surface forming opening 64. Such threads may be configured to engage restraining bolt 42. In such embodiments, bolt 42 may be fastened directly to flange 36, for example through engagement with the threads of opening 64.

With continuing reference to FIGS. 1-8, FIG. 9 illustrates a fragmented perspective view of a lower portion of doorpost 24 prior to being attached to coupling arrangement 28. As illustrated, a bore 66 is defined in the lower portion of doorpost 24. Bore 66 extends entirely through the lower portion of doorpost 24. When the lower portion of doorpost 24 is positioned between flange 36 and flange 38, bore 66 may be aligned with opening 60 and opening 62. When bore 66 and openings 60 and 62 are aligned, retaining pin 46 may be inserted there through to secure doorpost 24 to fitting 34 and, by extension, to floor surface 26.

In the illustrated embodiments, flanges 36 and 38 are depicted with round openings 60 and 62 which are axially aligned. In alternate embodiments, openings 60 and 62 as well as retaining pin 46 may be square, hexagonal, or any other shape which permits retaining pin 46 to engage the holes; that is, the openings may be of any geometric configuration which functions as a keyway for retaining pin 46. In this regard, the openings need not be axially aligned, for example if retaining pin 46 is slanted, angled, curved, or the like.

Moreover, the lower portion of doorpost 24 may be configured as a bore, keyway, one or more flanges, or any other configuration which cooperates with fitting 34 and retaining pin 46 to secure a body to a surface.

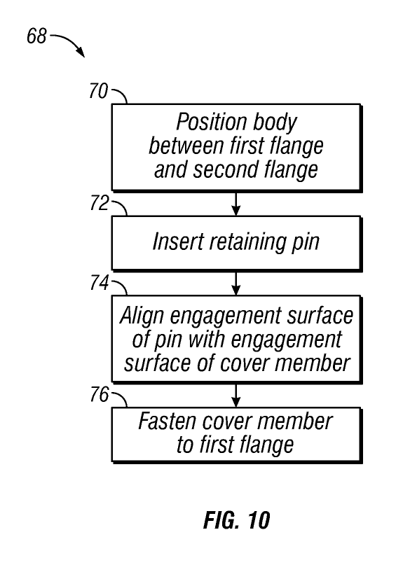

FIG. 10 is a block diagram illustrating an embodiment of a method 68 for attaching a body to a surface. At block 70, a body is positioned between a first flange and a second flange of a surface-mounted fitting. The first flange and the second flange are spaced apart and the body is configured to fit between the first flange and the second flange. The first flange and the second flange have axially aligned openings and the body defines a bore that extends there through. When positioning the body between the first flange and the second flange, the body should be manipulated such that the bore comes into substantial alignment with the openings in the first flange and the second flange.

At block 72, a retaining pin is inserted through the opening of the first flange, through the bore of the body, and through the opening in the second flange such that a portion of the retaining pin protrudes through the opening of the second flange.

At block 74, the cover member is positioned over a head of the retaining pin. The head of the retaining pin and the cover member each have engagement surfaces that are configured to cooperate with one another to prevent rotation of the retaining pin. When positioning the cover member over the head of the retaining pin, care should be taken to align the engagement surface of the cover member with the engagement surface of the head of the retaining.

At block 76, the cover member is fastened to the first flange. The cover member is configured to obstruct outward movement of the retaining pin from the opening in the first flange, the bore and the opening and the second flange. Accordingly, once the cover member is fastened to the first flange and engages the retaining pin, the body is anchored to the surface. By following the above described method steps, a single worker may attach the body to the surface even in circumstances where the worker has access to only one side of the surface mounted fitting.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A coupling arrangement for mounting a body to a surface, the body having a bore defined there through, the coupling arrangement comprising:
a fitting configured for attachment to the surface, the fitting having a first flange and a second flange spaced apart from the first flange, the first flange having a first opening and the second flange having a second opening;
a retaining pin configured to extend through the first opening, the bore, and the second opening when a portion of the body is positioned between the first flange and the second flange such that the bore is aligned with the first opening and the second opening; and
a cover member configured to be fastened to the first flange and to obstruct outward movement of the retaining pin from the first opening, the bore, and the second opening when the cover member is fastened to the first flange.

2. The coupling arrangement of claim 1, wherein the retaining pin has a first end and a second end, wherein the first end includes a head portion configured to obstruct movement of the first end through the first opening.

3. The coupling arrangement of claim 2, wherein the head portion is larger than the first opening.

4. The coupling arrangement of claim 2, wherein the first opening has a first diameter, wherein the head portion has a generally circular configuration having a second diameter, and wherein the second diameter is greater than the first diameter.

5. The coupling arrangement of claim 2, wherein the head portion has a first engagement surface and the cover member has a second engagement surface, and wherein the first engagement surface and the second engagement surface are configured to cooperate with each other to inhibit rotational movement of the retaining pin about a longitudinal axis thereof.

6. The coupling arrangement of claim 5, wherein the first engagement surface is substantially flat and wherein the second engagement surface is substantially flat.

7. The coupling arrangement of claim 1, wherein the retaining pin has a first end and a second end and wherein the first end defines a threaded bore.

8. The coupling arrangement of claim 1, wherein the retaining pin has a first end and a second end, wherein the first end includes a head portion, and wherein the head portion defines a notch defined in a surface of the head portion that faces towards the second end.

9. The coupling arrangement of claim 1, wherein the retaining pin has a first end and a second end and wherein the second end is tapered.

10. The coupling arrangement of claim 1, wherein the cover member defines a third opening, wherein the first flange defines a forth opening, and wherein the arrangement further comprises a restraining bolt configured for insertion through the third opening and the forth opening to attach the cover member to the first flange.

11. The coupling arrangement of claim 10, further comprising threads associated with the forth opening to engage the restraining bolt.

12. The coupling arrangement of claim 10, further comprising a nut configured to engage the restraining bolt, wherein the nut and the restraining bolt cooperate to attach the cover member to the first flange.

13. The coupling arrangement of claim 12, wherein the nut is attached to the first flange proximate the forth opening.

14. The coupling arrangement of claim 1, wherein the surface comprises a floor surface.

15. The coupling arrangement of claim 1, wherein the surface comprises a floor surface of an aircraft.

16. The coupling arrangement of claim 1, wherein the body comprises a door post.

17. The coupling arrangement of claim 1, wherein the first flange and the second flange are spaced apart by a distance that is substantially equal to an axial length of the bore.

18. The coupling arrangement of claim 1, wherein the first opening, the second opening, the bore, and the retaining pin each have a substantially circular cross section.

19. A method for mounting a body having a bore defined there through to a surface using an arrangement including a fitting attached to the surface, the fitting having a first flange and a second flange spaced apart from the first flange, the first flange having a first opening and the second flange having a second opening substantially axially aligned with the first opening, the arrangement further including a retaining pin configured to extend through the first opening, the bore, and the second opening, and the arrangement further including a cover member configured to be fastened to the first flange and to obstruct outward movement of the retaining pin from the first opening, the bore, and the second opening when the cover member is fastened to the first flange, the method comprising the steps of:
positioning the body between the first flange and the second flange such that the bore, the first opening, and the second opening are axially aligned;
inserting the retaining pin through the first opening, the bore and the second opening; and
fastening the cover member to the first flange in a position that obstructs outward movement of the retaining pin from the first opening, the bore, and the second opening.

20. The method of claim 19, wherein the retaining pin includes a head portion comprising a first engagement surface, wherein the cover member comprises a second engagement surface, wherein the first engagement surface and the second engagement surface are configured to cooperate to inhibit rotational movement of the retaining pin about a longitudinal axis of the retaining pin, the method further including the step of aligning the first engagement surface with the second engagement surface.
